(19) United States
(12) Patent Application Publication
(10) Pub. No.: US 2026/0236385 A1
(43) Pub. Date: Aug. 13, 2026

(54) INTERFACE CIRCUITRY

(71) Applicant: Arm Limited, Cambridge (GB)

(72) Inventors: Sven Ola Johannes HUGOSSON, Lund (SE); Klas Magnus BRUCE, Leander, TX (US)

(21) Appl. No.: 19/051,583

(22) Filed: Feb. 12, 2025

(51) Int. Cl. G06F 12/02

(52) U.S. Cl. CPC G06F 12/0223; G06F 12/0831; G06F 12/1009

(57) ABSTRACT

An apparatus comprises interface circuitry to exchange signals with one or more requesters. A to-be-translated memory access request specifies a target address to be translated to identify a location in a memory system to be accessed. In response to a to-be-translated memory access request received at the interface circuitry from a given requester, the interface circuitry issues a request acknowledgement to the given requester acknowledging the to-be-translated memory access request independent of whether the to-be-translated memory access request satisfies an observability condition.

### BACKGROUND

### Technical Field

The present technique relates to the field of data processing.

### Technical Background

A data processing apparatus may have translation circuitry such as a memory management unit (MMU) for managing accesses to memory. For example the translation circuitry may be responsible for translating virtual addresses specified by a device wishing to access memory into physical addresses which directly identify the locations to access in memory. The translation circuitry may also control whether a device is allowed to access the requested address based on access permissions set for regions of the address space. A processing element capable of instruction execution, such as a central processing unit, may have its own translation circuitry for managing access to memory in response to memory access transactions issued by the processing element. However, a processing system may also have requester devices which do not have their own address translation circuitry. Supporting address translation for memory access transactions (e.g., read/write transactions) issued by requester devices can be helpful to avoid exposing physical memory directly to devices. This can be beneficial both for supporting virtual memory (allowing fragmentation of the memory used by a device across non-contiguous physical memory regions), and for security reasons (allowing access permissions checks to be imposed so that malicious devices cannot compromise data in memory not allocated for the device).

### SUMMARY

At least some examples of the present technique provide an apparatus comprising:
interface circuitry configured to exchange signals with one or more requesters; and control circuitry; wherein
in response to a to-be-translated memory access request received at the interface circuitry from a given requester, the to-be-translated memory access request specifying a target address to be translated to identify a location in a memory system to be accessed in response to the to-be-translated memory access request, the control circuitry is configured to control the interface circuitry to issue a request acknowledgement to the given requester acknowledging the to-be-translated memory access request independent of whether the to-be-translated memory access request satisfies an observability condition.

At least some examples provide a method comprising:
exchanging signals with one or more requesters; and
in response to a to-be-translated memory access request received from a given requester, the to-be-translated memory access request specifying a target address to be translated to identify a location in a memory system to be accessed in response to the to-be-translated memory access request, issuing a request acknowledgement to the given requester acknowledging the to-be-translated memory access request independent of whether the to-be-translated memory access request satisfies an observability condition.

At least some examples provide a computer program for controlling a host data processing apparatus to provide an instruction execution environment, the computer program comprising:
interface program logic to exchange signals with one or more requesters; and
control program logic; wherein
in response to a to-be-translated memory access request received by the interface program logic from a given requester, the to-be-translated memory access request specifying a target address to be translated to identify a location in a memory system to be accessed in response to the to-be-translated memory access request, the control program logic is configured to control the interface program logic to issue a request acknowledgement to the given requester acknowledging the to-be-translated memory access request independent of whether the to-be-translated memory access request satisfies an observability condition.

The computer program may be stored on a computer-readable storage medium. The storage medium may be non-transitory.

Further aspects, features and advantages of the present technique will be apparent from the following description of examples, which is to be read in conjunction with the accompanying drawings.

### BRIEF DESCRIPTION OF THE DRAWINGS

FIG. 1 schematically illustrates a data processing system;

FIG. 2 schematically illustrates communication channels between interface circuitry and a requester;

FIG. 3 is a ladder diagram schematically illustrating a process of a requester issuing a write transaction;

FIG. 4 is a ladder diagram schematically illustrating a write barrier transaction;

FIG. 5 schematically illustrates an example implementation of interface circuitry for providing a write response;

FIGS. 6 and 7 are flow diagrams illustrating methods of issuing a request acknowledgement;

FIG. 8 is a flow diagram illustrating a method of handling a write barrier transaction;

FIG. 9 illustrates a simulation example; and

FIG. 10 illustrates a system and a chip-containing product.

### DESCRIPTION OF EXAMPLES

In some examples, an apparatus comprises interface circuitry configured to exchange signals with one or more requesters. As will be discussed below, the requesters are not particularly limited and could include input/output (I/O) devices, hardware accelerators, and core local accelerators, for example. The requesters may generally lack address translation circuitry and hence issue a to-be-translated memory access request to the interface circuitry specifying a target address (e.g., virtual address, or intermediate physical address) to be translated to identify a location in a memory system (e.g., using a physical address) to be accessed in response to the to-be-translated memory access request.

The apparatus comprises control circuitry responsive to a to-be-translated memory access request from a given requester to control the interface circuitry to issue a request acknowledgement to the given requester. The request acknowledgement may indicate that the request has been received by the interface circuitry (for example, indicating that the request is locally visible to the receiver of the to-be-translated memory access request).

It may be beneficial to provide a mechanism to enable a requester to determine when requests sent to the apparatus are visible within a wider processing system. For example, when the apparatus provides an interface to the memory system, such a mechanism may enable the requester to determine when a particular request sent to the apparatus is visible to other requester devices also having access to the memory system. In some alternative examples, an acknowledgement issued by the interface circuitry in response to a given request may provide such a mechanism and may act as an indication that the request satisfies an observability condition (e.g., a global observability condition). Using the request acknowledgement to indicate observability may form part of a general trend towards reducing data barriers in a processing system.

However, waiting to ensure that a request satisfies the observability condition before issuing an acknowledgement may result in longer delays between a requester issuing a request and receiving an acknowledgement. For a memory access request specifying a physical address, this increased delay may not be a particular issue. However, the inventors have realised that there may be additional overhead associated with handling to-be-translated requests, and in particular to-be-translated requests may be tracked more extensively by a requester prior to receiving the write response. For example, to account for the possibility of an address translation fault, a requester may track a to-be-translated request until a write response indicating successful translation has been received. An overhead associated with tracking a to-be-translated request before receiving the write response may therefore be significant.

According to examples of the present technique the control circuitry is configured to control the interface circuitry to issue a request acknowledgement to the given requester acknowledging the to-be-translated memory access request independent of whether the to-be-translated memory access request satisfies an observability condition. For instance, the request acknowledgement may be issued without determining whether the observability condition is satisfied, and the request acknowledgement may be issued even if it has been determined that the observability condition is not satisfied.

The inventors have realised that, although going against a prevailing trend of using acknowledgements to indicate observability (which may allow a total volume of traffic on the interface to be reduced compared to using separate messages to indicate observability), issuing the request acknowledgement for a to-be-translated request independent of the observability condition may enable the request acknowledgement to be issued earlier, which in the context of to-be-translated requests may provide improvements at the requester and completer of the to-be-translated request. In particular, this means that to-be-translated memory access requests may require tracking for less time, meaning that fewer requests may be tracked simultaneously and hence tracking structures for to-be-translated memory access requests may be made smaller, which can result in area and power improvements for the requester and receiver of the to-be-translated memory access requests. A requester may also delay certain actions after sending a to-be-translated request, such as sending a subsequent request which should be ordered with respect to the to-be-translated request, until receiving the request acknowledgement, and therefore issuing the request acknowledgement for the to-be-translated request independent of the observability condition may allow those actions to be performed earlier.

The observability condition may take various forms. In general, determining whether the observability condition is satisfied for a given request may comprise determining whether the given request is visible to other requesters which may access the memory system. For example, if the request is a write request to write data to a target physical address then the request may be observable when the write data is visible to the other requesters seeking to access the target physical address and local cached copies of the previous data associated with the target physical address have been invalidated. The observability condition may also be termed a global observability condition.

In some examples, the memory system may comprise a coherent interconnect connecting memory system requesters to memory system completers (e.g., memory storage units), where the coherent interconnect may support a coherency protocol providing features for guaranteeing cache coherency of data from the memory system cached in respective private caches associated with a plurality of memory system requesters. In some examples, the observability condition may be satisfied for a memory access request which is visible to coherency transactions of the memory system, such as coherency transactions of the coherency protocol supported by the coherent interconnect.

The amount of time taken for requests issued by the given requester to be received at the interface circuitry may vary, and the requester may not be able to trust that an order in which requests are issued matches an order in which requests are received by the apparatus. In some examples, the request acknowledgement may enable the given requester to determine a relative ordering of the to-be-translated memory access request with respect to other memory access requests issued by the given requester. Providing the request acknowledgement may therefore enable the given requester to perform certain actions which may require a certain ordering to be established. For example, the request acknowledgement may enable the given requester to issue a memory access request which should logically follow the to-be-translated request (and which may be buffered at the given requester until the request acknowledgement is received). By issuing the request acknowledgement independent of the observability condition, this can enable actions depending on the ordering of the to-be-translated request to be performed earlier, and can hence improve performance as well as providing area improvements by reducing an amount of storage required for buffering at the given requester.

The manner in which the request acknowledgement enables the given requester to determine a relative ordering of the to-be-translated memory access request is not particularly limited. In some examples, issuing the request acknowledgement enables the given requester to determine that a subsequent memory access request issued by the requester following receipt of the request acknowledgement is ordered with respect to the to-be-translated memory access request. Receiving the request acknowledgement indicates to the given requester that the interface circuitry has received the to-be-translated memory access request, and hence any later request issued after receiving the request acknowledgement must be ordered at the interface circuitry later than the to-be-translated memory access request. In contrast, a further request issued by the given requester before it receives the request acknowledgement may be received at the interface circuitry before or after the to-be-translated memory access request, and hence may be considered by the given requester to be unordered with respect to the to-be-translated memory access request.

As described above, according to the present techniques the request acknowledgement is issued in response to the to-be-translated memory access request independent of whether the observability condition is satisfied. Hence, the request acknowledgement does not allow the given requester to determine whether the to-be-translated memory access request is globally visible on the memory system. However, it may be desirable to enable the given requester to determine whether a to-be-translated memory access request satisfies the observability condition (e.g., before performing a subsequent action depending on the earlier request being globally observable). Therefore, in some examples the given requester and the control circuitry may support a barrier transaction. In response to the barrier transaction received at the interface circuitry from the given requester, the control circuitry may be configured to control the interface circuitry to issue a barrier response in response to determining that each memory access request of at least one type issued before the barrier transaction satisfies the observability condition. Hence, the given requester receiving a response to the barrier transaction indicates that memory access requests of the at least one type preceding the barrier transaction satisfy the observability condition, and hence the barrier transaction can be used to determine observability of memory access requests.

The barrier transaction may therefore provide a guarantee that if another requester can observe a memory access request issued after the barrier then it must be able to observe every transaction issued before the barrier.

The at least one type of memory access request is not particularly limited, and for a general barrier may include all types of memory access request such that the barrier response is issued in response to all preceding memory access requests satisfying the observability condition. However, in other examples may be more restricted. For example, in response to a write barrier transaction received at the interface circuitry from the given requester (for which the at least one type of memory access request is limited to write memory access requests for writing data to a memory location associated with a target address), the control circuitry may be configured to control the interface circuitry to issue a write barrier response in response to determining that each write request issued before the write barrier transaction satisfies the observability condition.

The apparatus may support multiple barrier transactions being in flight at the same time, with each outstanding barrier transaction being identified by a unique transaction identifier allowing the requester to match barrier responses to issued barrier transactions. However, in some examples the apparatus may not support multiple outstanding write barriers. In response to the barrier transaction, the interface circuitry could for example be configured to stall a channel configured to receive the barrier transaction until the barrier response is issued. According to such an approach, the barrier transaction may not need to specify a unique identifier, and this may simplify tracking of outstanding barrier transactions for the given requester.

The to-be-translated memory access request is not particularly limited. In some examples, the control circuitry may be configured to control the interface circuitry to issue a request acknowledgement acknowledging a to-be-translated memory access request independent of whether the to-be-translated memory access request satisfies an observability condition for a subset of types of to-be-translated memory access request, and may handle different types of memory access request differently. The subset of types may for example include write requests and read requests. However, in some examples, the control circuitry may be configured to control the interface circuitry to issue a write acknowledgement to the given requester acknowledging a to-be-translated write request independent of whether the to-be-translated write request satisfies the observability condition, and configured to control the interface circuitry to issue a read acknowledgement to the given requester acknowledging a to-be-translated read request in response to determining that the read request satisfies the observability condition. Hence, a request acknowledgement for a to-be-translated write request may not indicate that the observability condition is satisfied for that write request, while a request acknowledgement for a to-be-translated read request may indicate that the observability condition is satisfied for that read request.

By waiting to issue the read acknowledgement until the observability condition is satisfied, this avoids the requester being required to use a barrier transaction to determine observability of to-be-translated read requests. This can reduce an amount of traffic over the interface. Requiring the observability condition to be satisfied before issuing a request acknowledgement for read transactions but not for write transactions may be considered unusual. However, read transactions may be represented using less storage than write transactions (which may be accompanied by payload data), and hence the increased duration for which the read transaction may be tracked in queues whilst waiting for the request acknowledgement (whilst waiting for the observability condition to be satisfied) may be associated with a smaller area cost than waiting for the observability condition to be satisfied for write transactions, and hence the inventors have realised that it may be beneficial to issue the request acknowledgement differently for read transactions and write transactions.

Although the control circuitry may cause the request acknowledgement for a to-be-translated request to be issued independent of the observability condition, there may be other conditions which may be required to be satisfied before the request acknowledgement can be issued. These are not particularly limited, and may be implementation dependent. In some examples, the control circuitry may be configured to control the interface circuitry to issue the request acknowledgement to the given requester in response to determining that translation of the target address has been completed. The requester device and the apparatus comprising the interface circuitry may for example maintain queues tracking pending to-be-translated memory access requests in case the translation is unsuccessful and the request needs to be re-issued. For example, in response to a response indicating a translation error, the requester may re-issue the to-be-translated memory access request, and hence may maintain a queue of requests for which the translation has not yet been successful. If the request acknowledgement is issued in response to a determination that the translation is complete, then this may allow entries to be removed from the queues when the translation is successful, and hence issuing such a response without waiting for the observability condition to be satisfied may enable such queues to be smaller (and therefore provide area savings at the requester).

In some examples, the apparatus may comprise status storage circuitry configured to provide status information relating to the given requester. The status information may for example be visible to software executing on the processing circuitry provided by the apparatus,. In some examples, the control circuitry may be configured to set a write observability indicator in the status storage circuitry in dependence on whether all write requests received from the given requester satisfy the observability condition. The write observability indicator may therefore indicate when all received write requests are globally observable, which can provide a control agent (e.g., software) with a greater level of information for making control decisions regarding the given requester. For example, the write observability indication may indicate when more intrusive actions may be taken which might not be possible while a to-be-translated request is pending and not yet globally observable. For example, the write observability indicator may be used to identify times when it is appropriate to power down the given requester, update page tables used to translate requests received from the given requester, and so on. The control circuitry may be configured to set the write observability indicator in dependence on further conditions, for example including a determination that all read requests received from the given requester also satisfy the observability condition.

In some examples, the control circuitry may be configured to set the write observability indicator in dependence on whether the given requester is in an idle state in which the given requester is expected to issue no further memory access requests. For example, the write observability indicator may have a first state when all preceding writes (and optionally reads) are globally observable and the requester is in the idle state, and the write observability indicator may have a second state when any of those conditions is not met. The control circuitry may for example receive a signal from the given requester indicating whether that requester is in the idle state. Setting the write observability indicator when the given requester is in the idle state means that the write observability indicator may indicate that there are no currently pending requests and there is no expectation for there to be any upcoming pending requests, which can provide a useful signal to a control agent that intrusive actions may be taken.

As described above, the present techniques may be used with a range of different requesters and examples of the interface circuitry. In some examples, the requesters may comprise input/output (I/O) devices and the interface circuitry may be provided by a system memory management unit (SMMU) provided for translating memory access requests initiated by the I/O devices.

In some examples, the interface circuitry may be provided by an apparatus comprising processing circuitry to execute instructions, and the interface circuitry may comprise accelerator control interface circuitry configured to exchange control signals with at least one hardware accelerator configurable, based on instructions executed by the processing circuitry, to perform a delegated task. In this example, the one or more requesters may comprise the at least one hardware accelerator. Hence, the to-be-translated memory access request may be provided to an apparatus (e.g., a CPU) by a hardware accelerator configurable by that apparatus to perform delegated tasks. In such an arrangement, the hardware accelerator accesses the memory system using virtual addresses, and reuses the memory management circuitry of the processing circuitry for address translation. This differs from conventional hardware accelerator implementations, which would either access memory using physical addresses to avoid any need for accelerator-triggered memory accesses to be subject to address translation at all, or route accelerator-triggered memory accesses via system memory management circuitry separate from the memory management circuitry associated with the processing circuitry.

As the accelerator-triggered memory access requests specify virtual addresses, and the memory management circuitry of the processing circuitry is reused to translate the virtual addresses specified by a hardware accelerator, this greatly reduces the software complexity in configuring the hardware accelerator, as the hardware accelerator can simply see the same virtual address space as the process running on the processing circuitry that configured the hardware accelerator to perform the delegated task. Unlike systems where physical addresses are used for accelerator-triggered accesses, there is no need for use of memory pinning (software locking of page table entries that map the physical memory used by a hardware accelerator, to prevent those regions of physical memory being reallocated for other purposes until the accelerator has completed its task using that physical memory). Such memory pinning would typically incur a performance cost because a more privileged piece of software may need to be called to manage the memory pinning, interrupting the process that is requesting use of the hardware accelerator. Also, avoiding the need for a separate system memory management unit to translate accelerator accesses helps reduce software control overhead as typically the system memory management unit may have an entirely separate set of control structures configurable by software, compared to the control structures used to control the memory management circuitry associated with the processing circuitry. Hence, reusing the processing circuitry's memory management circuitry (which is also used for translations performed in response to memory access instructions executed by the processing circuitry) for translation of accelerator-triggered memory access requests is helpful for reducing the software overheads associated with configuring the accelerator. This can make it more feasible for the accelerator to be used for relatively short delegated tasks for which the configuration overhead would otherwise be prohibitive, thus giving more opportunities to free the main processing circuitry for other purposes, and hence helping to improve processing performance in the system as a whole.

By providing a request acknowledgement in response to a to-be-translated memory access request issued by a hardware accelerator independent of the observability condition, the area advantages described above can be obtained for the hardware accelerator, which may improve feasibility of providing such a hardware accelerator and hence enable processing performance to be improved in the system as a whole.

In some examples providing accelerator control interface circuitry, the apparatus may comprise memory management circuitry associated with the processing circuitry, to perform address translation in response to memory access instructions executed by the processing circuitry, and in response to the to-be-translated memory access request received at the interface circuitry from the given requester, the memory management circuitry associated with the processing circuitry is configured to translate the target address specified by the to-be-translated memory access request to a physical address of a memory system location to be accessed in response to the to-be-translated memory access request. Hence as discussed above, the hardware accelerator re-uses translation circuitry provided for the processing circuitry.

In some examples, the at least one hardware accelerator is private to a processor core comprising the processing circuitry. Hence, the hardware accelerator may be tightly coupled to a specific processor core and may not be shareable with other processor cores. This differs from other hardware accelerator designs where a shared accelerator is provided further out in the memory system which is able to be used by any of two or more processor cores.

As described above, by issuing the request acknowledgement independent of the observability condition, the control circuitry may be configured to control the interface circuitry to issue a request acknowledgement to the given requester acknowledging the to-be-translated memory access request at a time when the to-be-translated memory access request does not satisfy the observability condition. The control circuitry may similarly control the interface circuitry to issue a request acknowledgement to the given requester acknowledging the to-be-translated memory access request at a time when the to-be-translated memory access request does satisfy the observability condition, and at times when it is not known whether or not the to-be-translated memory access request satisfies the observability condition.

Particular examples will now be described with reference to the Figures.

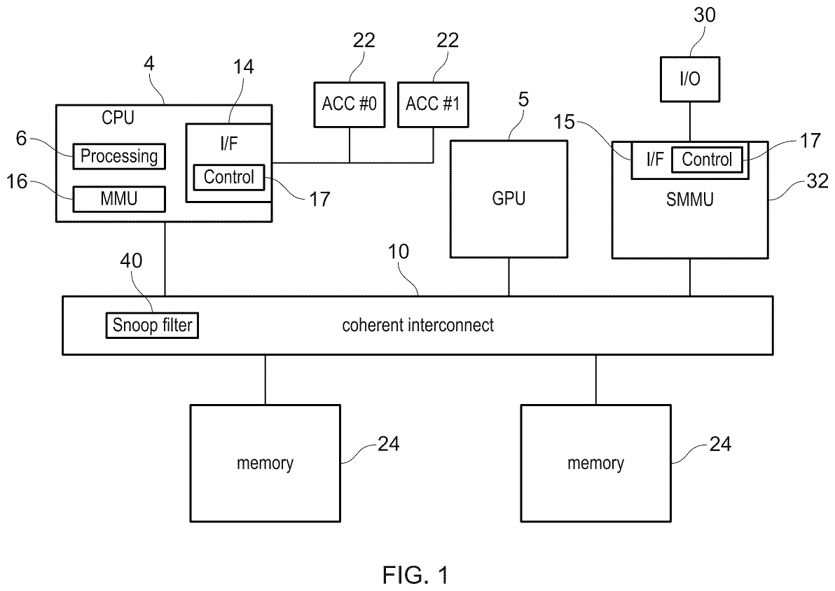

FIG. 1 schematically illustrates an example of a data processing system (e.g. an integrated circuit or system-on-chip) which includes a number of interconnect requester devices 4, 5, 32 and an interconnect 10 for connecting the devices to memory 24 and for managing coherency between caches in the devices and other caches. In this example the interconnect requester devices include a central processing unit (CPU) 4 for performing general purpose processing, a graphics processing unit (GPU) 5 for performing graphics processing, and a system memory management unit (SMMU) 32. The interconnect requester devices includes caches, e.g. the CPU 4 may include level 1 caches associated with particular cores and a shared level 2 cache. Each of the devices may have a coherency interface for interacting with the coherent interconnect. For example, the coherency interface of a particular interconnect requester may be responsible for generating the required coherency protocol transactions in response to memory accesses from that interconnect requester, and responding to snoop requests from the interconnect 10 with appropriate responses and changes of coherency state. It will be appreciated that this is just one example of some devices and other types of devices could also be provided, such as a network interface controller (NIC) for controlling transmission and reception of data over a network, display controllers for controlling display of data on a screen, or a DMA (direct memory access) controller for controlling transfer of data between memory and a peripheral device for example. Examples of coherency protocols which could be used are the AMBA® 4 ACE and AMBA® 5 CHI coherency protocols provided by ARM® Ltd of Cambridge, UK, but it will be appreciated that the techniques discussed herein could also be applied to other coherency protocols.

A system cache may be coupled to the coherent interconnect 10 but not assigned to a particular device. The system cache may, for example, be provided to speed up access to data by uncached requesters, allowing faster access than if all reads and writes from the uncached requester have to be served by main memory 24. The system cache has a coherency interface for responding to snoop requests or linefills of data from the coherent interconnect.

As shown in FIG. 1, the coherent interconnect 10 may include a snoop filter 40 for tracking which data addresses are cached at certain requester devices. The snoop filter 40 can be used to reduce snoop traffic by allowing the coherent interconnect 10 to determine when data is not cached at a particular requester. The snoop filter 40 is not essential, and some embodiments may provide an interconnect 10 which does not attempt to track the data cached at each requester. In this case, when one interconnect requester issues a read or write transaction to data which could be shared with other interconnect requesters, the coherent interconnect 10 may trigger snoop transactions to be issued to each other interconnect requester which could have a cached copy of the data from the same address, and manage changes in coherency state at those other requesters and/or responses to the requesting requester with more up to date versions of the data as necessary. However, if there are a lot of requesters, then this approach of broadcasting snoops to all cached requesters can be complex and result in a large volume of coherency traffic being exchanged within the system. By providing a snoop filter 40 which can at least partially track which addresses are cached at the respective interconnect requesters, this can help to reduce the volume of snoop traffic.

The CPU 4 comprises processing circuitry 6 to execute instructions defined according to an instruction set architecture (ISA) to carry out data processing operations represented by the instructions. The processing circuitry performs operations on data loaded from a memory system, and may store the results back to the memory system.

The CPU 4 also comprises a memory management unit 16 (MMU, an example of address translation circuitry), to perform address translation in response to memory access instructions executed by the processing circuitry. The MMU 16 translates virtual addresses specified by memory access requests into physical addresses identifying storage locations of data in the memory system. The MMU 16 has a translation lookaside buffer (TLB) for caching address translation data from page tables stored in the memory system, where the page table entries of the page tables define the address translation mappings and may also specify access permissions which govern whether a given process executing on the pipeline is allowed to read, write or execute instructions from a given memory region.

The data processing apparatus also includes one or more hardware accelerators 22 configurable, based on instructions executed by the processing circuitry of the CPU 4, to perform a delegated task, asynchronously with respect to operations performed by the processing circuitry of the CPU in response to executed instructions. A hardware accelerator 22 is unique (private) to a single processor core 4, and therefore may be referred to as a core local accelerator (CLA). The hardware accelerator 22 is controlled by, and communicates with the memory system via, an associated processor core 4. The CPU 4 therefore comprises accelerator control interface circuitry 14 (a core local accelerator control module (CLAC)) to exchange control signals with the at least one hardware accelerator 22, under the control of interface control circuitry 17.

The hardware accelerators 22 access the memory system via the CPU 4, and issue accelerator-triggered memory access requests using virtual addresses (which are hence to-be-translated memory access requests). In response to an accelerator-triggered memory access request received at the accelerator control interface circuitry 14 from a given hardware accelerator 22, the MMU 16 translates a virtual address specified by the accelerator-triggered memory access request to a physical address of a memory system location to be accessed in response to the accelerator-triggered memory access request. Hence, the hardware accelerator reuses the memory management circuitry of the processing circuitry for address translation. The MMU 16 may translate the virtual address of an accelerator-triggered memory access request according to address mapping information associated with the virtual address and a given address translation context. The address translation context may be an address translation context which was a current address translation context of the processing circuitry of the CPU 4 at the time of execution of an instruction which caused launch of an accelerator command which caused the accelerator-triggered memory access request to be issued (e.g., the address translation context at the time a task was delegated), and hence may be a different address translation context to a current address translation context of the processing circuitry of the CPU 4.

FIG. 1 also illustrates an input/output (I/O) device 30, and a system memory management unit (SMMU) 32. The I/O device 30 accesses the memory system via the SMMU 32, and issues memory access requests using virtual addresses (which are therefore to-be-translated memory access requests). The SMMU 32 translates the virtual address of the to-be-translated memory access request into a physical address identifying a location in the memory system. The SMMU 32 comprises interface circuitry 15 for communicating with the I/O device 30 under the control of interface control circuitry 17. Although not shown in FIG. 1, the SMMU 32 may translate memory access requests for a plurality of I/O devices.

Hence, a data processing system may be provided including multiple interconnect requesters 4, 5 connected by a coherent interconnect to a memory system, and further requesters 22, 30 which issue to-be-translated memory access requests (e.g., read and write transactions) to a local device for translation (e.g., a CPU 4 or SMMU 32) to access data in the memory system.

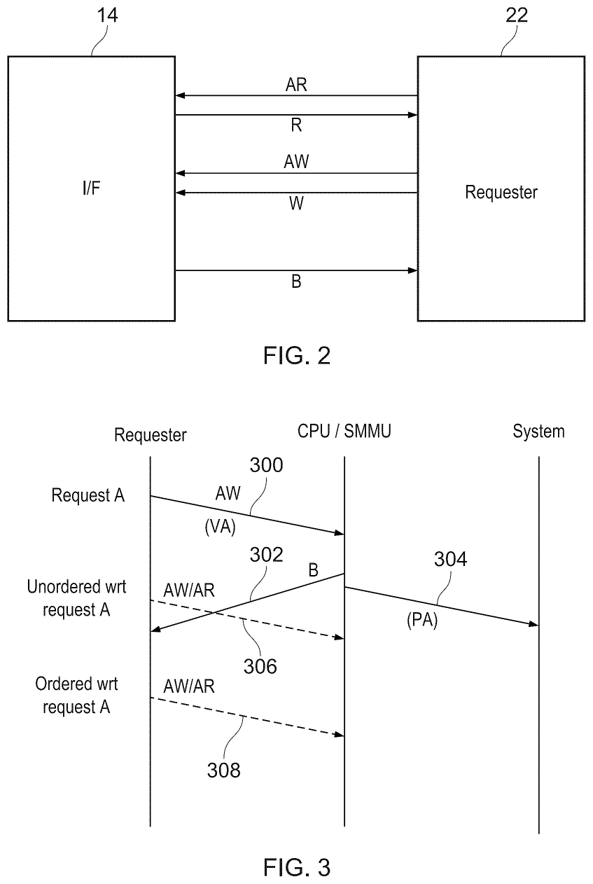

FIG. 2 illustrates communication channels between a CPU 4 and a given hardware accelerator 22. It will be appreciated that the communication channels illustrated in FIG. 2 may also be used for communication between a requester and interface circuitry more generally, such as between an SMMU 32 and an I/O device 30, and that the interface of FIG. 2 is merely an example and the present techniques may be used with interfaces having a different configuration. FIG. 2 illustrates memory interface channels comprising a read address channel (AR), a read data channel (R), a write address channel (AW), a write data channel (W), and a response channel (B). In some examples, multiple read and/or write channels may be supported, and hence for example two or more copies of the AR and R channels may be provided, and so on. To issue a write transaction, the requester (e.g. accelerator 22) issues a transaction on the AW channel with accompanying write data on the W channel. A read transaction is issued on the AR channel with the data being returned via the R channel. The response channel B is used to acknowledge certain transactions, such as by providing a write response.

In some examples, the memory interface channels may support multiple transactions being in flight at the same time, identifying each outstanding transaction using a unique transaction ID. The transaction ID may allow read data to be associated with a particular read request, or a write response to be associated with a particular write transactions, for example. In the case that multiple requesters (e.g. accelerators 4) are provided, messages communicated on the memory interface channels may specify a requester ID, e.g., as part of the transaction ID or as a separate signal. To support a receiver and requester (e.g., CPU 4 and accelerator 22) running at different frequencies, the channels may use asynchronous bridges.

FIG. 3 is a ladder diagram schematically illustrating a process of a requester (e.g., hardware accelerator 22) issuing a write transaction via an interface 14 to a translation device (e.g., an interconnect requester, such as the CPU 4) comprising translation circuitry for translating the request and issuing the request to a memory system.

At step 300, the requester 22, 30 issues a write request transaction (“request A”) via the AW channel to interface circuitry 14,15 within the translation device. In this example, the write request specifies a virtual address identifying a location in a memory system to be accessed, and accompanying write data to be written to that location is provided via the W channel. The write transaction is identified by a unique transaction identifier, which may be used to match write requests to write responses.

At step 302, after the interface circuitry 14, 15 receives the write transaction, interface control circuitry 17 controls the interface circuitry 14, 15 to issue a write response to the write request. The write response is issued over the response channel B.

The write response indicates that the write transaction is visible to the device comprising the interface circuitry, e.g., the local CPU core 4 or SMMU 32.

The write response is issued independent of whether that write request is observable to other requester devices in the data processing system. For example, the acknowledgement is issued independent of whether the write request is visible to coherency protocol messages, such as snoop requests, issued on the coherent interconnect 10. Hence, the write response does not indicate whether the write transaction is visible to other cores in the processing system.

The write response may indicate whether the write transaction succeeded or faulted, and in particular may indicate translation faults. Hence, in some examples, the write response may not be issued until a translation of the virtual address specified by the write transaction has finished (either successfully or unsuccessfully).

By issuing the write acknowledgement 302 independent of whether the request is globally observable, this can allow the write acknowledgement 302 to be issued earlier than an alternative example in which the acknowledgement indicates observability (and hence is delayed until the write request is made observable). A write transaction may only become observable after relevant coherency protocol messages have been issued to other devices and appropriate responses have been received, and hence there may be a significant delay associated with waiting for a write transaction to be globally visible.

At step 304, the device comprising the interface circuitry causes the write to be performed to a target physical address obtained by translating the target virtual address specified in the write request. The write data provided on the W channel may for example be stored within a cache of the CPU 4, and coherency protocol messages may be issued to other requesters in the system (e.g., so they may invalidate out of date copies of data associated with the target physical address). Hence, at step 304 one or more requests may be issued via the coherent interconnect 10 specifying the target physical address. After step 304 (e.g., after receiving responses to any coherency messages issued at step 304) the write request may be considered globally observable within the system.

FIG. 3 illustrates that a memory access request, either a write issued on the AW channel or a read issued on the AR channel, issued before the requester receives the write acknowledgement is unordered with respect to the write request. That is, the requester cannot determine whether the subsequent request issued at step 306 will be ordered at the completer before or after the request issued at step 300.

In contrast, the memory access request issued (on the AW or AR channel) at step 308, after the write acknowledgement for request A is received, is known by the requester to be ordered after request A. That is, the requester knows that the CPU/SMMU must have received request A before the request issued at step 308, because the acknowledgement for request A was received before the request was issued at step 308.

A requester may delay issuing certain requests until those requests can be ordered with respect to an earlier request. Hence, issuing the write acknowledgement earlier may enable requests waiting for the acknowledgement before being issued to be issued earlier, which may allow the size of queues at the requester to be reduced. Therefore, issuing the write acknowledgement independent of whether the request 300 is observable may enable the size of queues at the requester to be reduced.

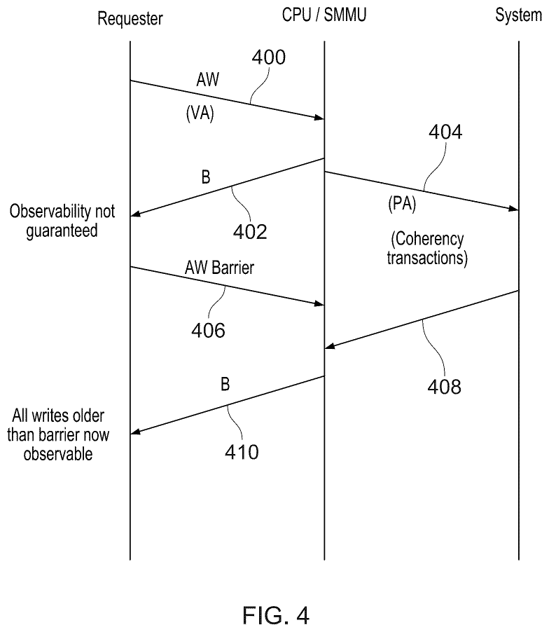

FIG. 4 is a ladder diagram schematically illustrating a write barrier transaction.

At step 400, the requester 22, 30 issues a write request via the AW channel to interface circuitry 14,15. As described above, at step 402 the interface circuitry provides a write acknowledgement response. The write acknowledgement is issued independent of whether the write request is globally observable and hence after receiving the write acknowledgement the requester is aware that the request is locally visible to the CPU 4 (or SMMU 32) comprising the interface, but does not know whether the request is globally observable to other requesters in the data processing system.

The requester may wish to guarantee global observability for the write request (e.g., before performing an action depending on the write request being observable), and hence at step 406 issues a write barrier transaction. The write barrier transaction is issued on the AW channel, and may for example use an encoding for which no payload is expected on the W channel (e.g., using a similar format to existing write transactions for which no accompanying data is provided). The write barrier may be queued at the receiver in the same way as a write request, e.g., in an order of receipt at the interface circuitry.

In response to the write request 400, the receiver (e.g., CPU 4) causes coherency protocol transactions to be issued to make the write request globally observable, and receives coherency transaction responses 408 indicating when the write request is globally observable.

At step 410 the interface circuitry issues a response to the write barrier transaction (on the B channel) in response to determining that all write transactions received before the write barrier transaction are globally observable (e.g., coherency responses where required have been received for all write requests received before the write barrier). For example, the write barrier transaction may be queued with write transactions handled in order, and the write barrier response may be issued when the write barrier transaction reaches a point in the queue where a write transaction would have become globally observable (e.g., when leaving the TQ discussed below), which hence guarantees that any earlier write transaction has reached that point and is hence globally observable.

In response to receiving the write barrier response, the requester is therefore able to determine that the write transaction issued at step 400 (and any other write transaction ordered earlier than the write barrier transaction) is observable, as this write transaction is ordered before the write barrier transaction and hence global observability of that write request was a condition for the write barrier response to be issued.

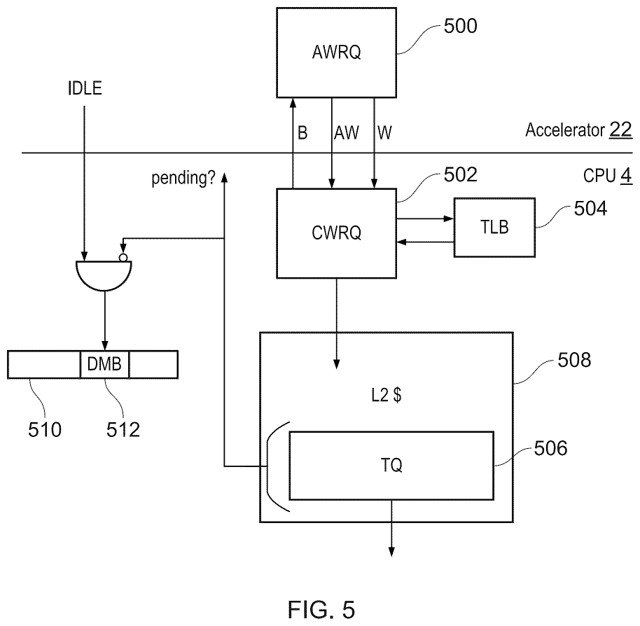

FIG. 5 schematically illustrates an example implementation of interface circuitry for providing a write response. FIG. 5 schematically illustrates the boundary between a core local accelerator 22 (above the horizontal line) and a CPU 4 for controlling that core local accelerator (below the horizontal line). Intervening circuitry handling the physical connection between the accelerator 22 and CPU 4 has been omitted for clarity. It will be appreciated that, while an accelerator 22 and CPU 4 are used in the example of FIG. 5, similar considerations apply for different requesters and receivers.

As shown in FIG. 5, the accelerator 22 comprises an accelerator write queue (AWRQ) 500. The AWRQ stores write transactions issued by the accelerator 22, including an indication of a target virtual address and write data. Write requests are issued from the AWRQ to the interface circuitry 14 of the CPU 4 via the AW and W channels, where the received request is tracked in a CPU write queue (CWRQ) 502.

Write transactions remain in the AWRQ 500, after being issued to the CPU 4, until a write response has been received on the B channel. For example, write transactions may be retained in case they were not delivered successfully and need to be re-issued. Requests may also be retained in the AWRQ in case a translation of the virtual address is unsuccessful and the write transaction needs to be reattempted.

The CWRQ 502 tracks write transactions pending translation. Address translation circuitry, such as a TLB 504, is provided to translate the virtual addresses specified by the write transaction into a physical address representing a memory location in the memory system to be accessed in response to the write transaction. The CPU 4 translates virtual addresses specified by the accelerator 22 using a translation context corresponding to a current state of the accelerator 22, which may be the translation context of the CPU 4 at the time a task was delegated to the accelerator 22 (and which may differ from a current translation context for memory access requests initiated by the CPU 4).

Once a translation has been completed for a write transaction, a write response is issued (on the B channel). The write response enables the accelerator 22 to remove the corresponding write request from the AWRQ 500, as this may indicate that the accelerator 22 is no longer required to re-issue the write transaction and hence no longer needs to store the write transaction.

Successfully translated write transactions may be moved from the CWRQ 502 to a transaction queue (TQ) 506 within a level 2 cache 508 of the CPU 4. The TQ 506 tracks outstanding transactions. Coherency transactions may be issued for transactions recorded in the TQ (e.g., snoop requests may be sent to other interconnect requests which may hold a copy of data associated with the same physical address as a transaction in the TQ), and once coherency responses have been received, transactions may leave the TQ 506 (e.g., the write data specified with the write transaction may be recorded in the level 2 cache 508, or read data returned in a snoop response may be recorded in the level 2 cache 508). Hence, the TQ 506 tracks transactions which are not globally visible.

By issuing the write response before knowing whether the write transaction is observable to other requesters (other cores), write transactions may remain pending in the AWRQ 500 for less time, and hence the AWRQ 500 may be made smaller, which can represent significant area savings at the accelerator 22. For instance, if a write transaction becomes visible when it leaves the TQ 506, then waiting for visibility before issuing the write response means that the AWRQ 500 would need to have a size corresponding to the size of the TQ 506. The TQ may in some implementations be large, e.g., having up to 256 entries, to support a large number of outstanding write transactions (and hence improve performance by not preventing the accelerator from issuing write transactions due to lack of TQ entries). Hence, a significant reduction in size of the AWRQ 500 may be obtained by issuing the write response before write transactions leave the TQ 506.

The CPU 4 may provide one or more accelerator status registers 510. Each accelerator status register may be associated with a particular hardware accelerator 22, and may indicate various attributes of the associated hardware accelerator. The status register may be updated in response to status transactions issued by the corresponding accelerator 22. For example, the status register may indicate whether the corresponding hardware accelerator is available, and may indicate progress of a delegated task delegated to that hardware accelerator 22 by the CPU 4. The status register may indicate whether the corresponding hardware accelerator is in an idle state. In the idle state the accelerator does not have any current or pending work to do.

The CPU 4 may comprise logic to determine when requests are pending in the TQ 506, hence indicating whether there are any previous accelerator reads or writes which are not globally visible.

The status register 510 comprises a DMB field 512. The DMB field 512 may indicate a first value (e.g., 1) if there are no pending transactions in the TQ 506 and the hardware accelerator 22 is in the idle state, and a second value (e.g., 0) otherwise. The DMB field may therefore indicate when there are no outstanding transactions, and not expected to be any outstanding transactions, from the hardware accelerator 22. This may provide an useful indication to software. For example, the DMB field may indicate when it is appropriate for software to update page tables associated with a particular hardware accelerator, or to power down the particular hardware accelerator.

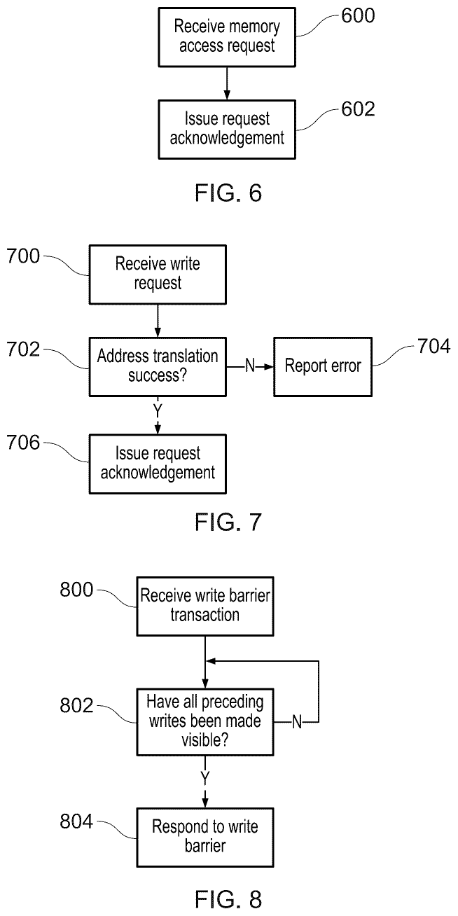

FIG. 6 is a flow diagram illustrating a method of handling a to-be-translated memory access request issued by a requester. At step 600, the to-be-translated memory access request is received via interface circuitry 14, 15 from the requester 22, 30. The to-be-translated memory access request specifies a target address (e.g., virtual address or intermediate physical address) which is to be translated to provide a target physical address identifying a location in a memory system. At step 602, the interface circuitry 14, 15 provides a request acknowledgement indicating visibility of the memory access request to the interface circuitry and the device comprising the interface circuitry, independent of whether the memory access request satisfies an observability (e.g., global observability) condition, where the observability condition may be satisfied for memory access requests which are visible to other requesters having access to the memory system (e.g., whether coherency transactions on a coherent interconnect connecting memory system requesters would identify the memory access request).

FIG. 7 is a flow diagram illustrating a method of handling a to-be-translated write request (which is an example of the to-be-translated memory access request of FIG. 6). At step 700, a write transaction is received at the interface circuitry 14, 15, including write data and indicating a target address to which the write data should be written. This request is not globally observable until read requests, issued by other requesters having access to the memory system, directed to the same physical address as the write request identify the write data of the write request. At step 702, the interface circuitry determines whether the target address specified by the write transaction has been successfully translated into a target physical address identifying the location in the memory system to which the write data should be written.

If the request was not successfully translated, then at step 704 a write response may be provided to the requester indicating (e.g., in the encoding of the write response) that the translation was unsuccessful. This may trigger the requester to re-issue the write transaction, for example. In response to issuing the response at step 704 the write transaction may be discarded by the receiver (e.g., by the CPU 4 or SMMU 32).

If the request was successfully translated, then at step 706 a write response may be provided to the requester indicating (e.g., in the encoding of the write response) that the translation was successful. In response to this write response, the requester may remove the write transaction from a local queue (e.g., the AWRQ) which may track transactions which may require repeating.

FIG. 8 is a flow diagram illustrating a method of handling a write barrier transaction. At step 800, a write barrier transaction is received by interface circuitry 14, 15 from a requester 22, 30. At step 802 control circuitry within the device comprising the interface circuitry determines whether all preceding writes received before the write barrier transaction satisfy an observability condition. When this is the case, the control circuitry 17 controls the interface circuitry 14, 15 to issue a write barrier response. The write barrier response indicates that all write transactions ordered before the write barrier transaction are globally visible.

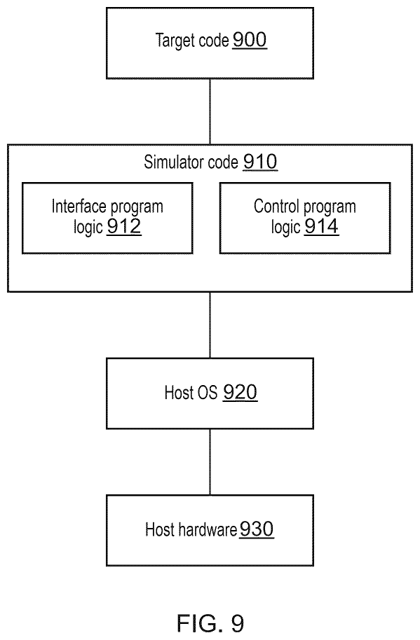

FIG. 9 illustrates a simulator implementation that may be used. Whilst the earlier described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor 930, optionally running a host operating system 920, supporting the simulator program 910. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described embodiments are present on the host hardware (for example, host processor 930), some simulated embodiments may make use of the host hardware, where suitable.

The simulator program 910 may be stored on a computer-readable storage medium (which may be a non-transitory medium), and provides a program interface (instruction execution environment) to the target code 900 (which may include applications, operating systems and a hypervisor) which is the same as the interface of the hardware architecture being modelled by the simulator program 910. Thus, the program instructions of the target code 900, including may be executed from within the instruction execution environment using the simulator program 910, so that a host computer 930 which does not actually have the hardware features of the apparatus 2 discussed above can emulate these features.

For example, the simulator code 910 may provide interface program logic 912 for controlling the host computer 930 to provide the functionality of the interface circuitry 14, 15, and control program logic 914 to provide the functionality of the control circuitry 17.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

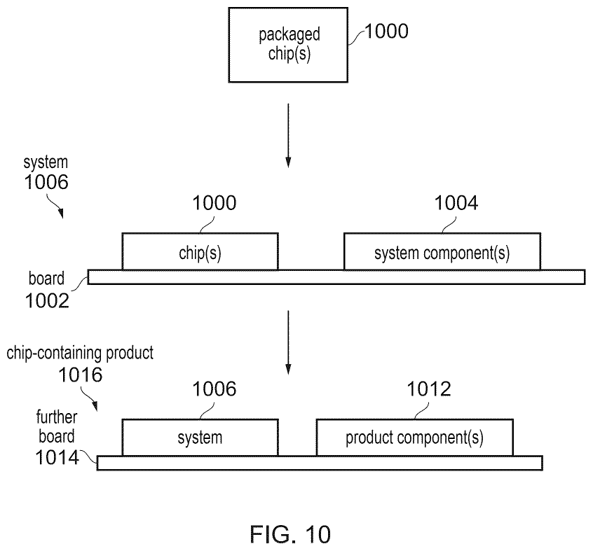

As shown in FIG. 10, one or more packaged chips 1000, with the apparatus described above implemented on one chip or distributed over two or more of the chips, are manufactured by a semiconductor chip manufacturer. In some examples, the chip product 1000 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 1000 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 1000 are assembled on a board 1002 together with at least one system component 1004 to provide a system 1006. For example, the board may comprise a printed circuit board. The board substrate may be made of any of a variety of materials, e.g. plastic, glass, ceramic, or a flexible substrate material such as paper, plastic or textile material. The at least one system component 1004 comprise one or more external components which are not part of the one or more packaged chip(s) 1000. For example, the at least one system component 1004 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 1016 is manufactured comprising the system 1006 (including the board 1002, the one or more chips 1000 and the at least one system component 1004) and one or more product components 1012. The product components 1012 comprise one or more further components which are not part of the system 1006. As a non-exhaustive list of examples, the one or more product components 1012 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 1006 and one or more product components 1012 may be assembled on to a further board 1014.

The board 1002 or the further board 1014 may be provided on or within a device housing or other structural support (e.g. a frame or blade) to provide a product which can be handled by a user and/or is intended for operational use by a person or company.

The system 1006 or the chip-containing product 1016 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Some examples are set out in the following clauses:
1. An apparatus comprising:
   interface circuitry configured to exchange signals with one or more requesters; and
   control circuitry; wherein
   in response to a to-be-translated memory access request received at the interface circuitry from a given requester, the to-be-translated memory access request specifying a target address to be translated to identify a location in a memory system to be accessed in response to the to-be-translated memory access request, the control circuitry is configured to control the interface circuitry to issue a request acknowledgement to the given requester acknowledging the to-be-translated memory access request independent of whether the to-be-translated memory access request satisfies an observability condition.
2. The apparatus according to clause 1, wherein the observability condition is satisfied for a memory access request which is visible to coherency transactions of the memory system.
3. The apparatus according to any preceding clause, wherein the request acknowledgement enables the given requester to determine a relative ordering of the to-be-translated memory access request with respect to other memory access requests issued by the given requester.
4. The apparatus according to clause 3, wherein issuing the request acknowledgement enables the given requester to determine that a subsequent memory access request issued by the requester following receipt of the request acknowledgement is ordered with respect to the to-be-translated memory access request.
5. The apparatus according to any preceding clause, wherein in response to a barrier transaction received at the interface circuitry from the given requester, the control circuitry is configured to control the interface circuitry to issue a barrier response in response to determining that each memory access request of at least one type issued before the barrier transaction satisfies the observability condition.
6. The apparatus according to clause 5, wherein in response to a write barrier transaction received at the interface circuitry from the given requester, the control circuitry is configured to control the interface circuitry to issue a write barrier response in response to determining that each write request issued before the write barrier transaction satisfies the observability condition.
7. The apparatus according to any of clauses 5 and 6, wherein in response to the barrier transaction, the interface circuitry is configured to stall a channel configured to receive the barrier transaction until the barrier response is issued.
8. The apparatus according to any preceding clause, wherein the control circuitry is configured to control the interface circuitry to issue a write acknowledgement to the given requester acknowledging a to-be-translated write request independent of whether the to-be-translated write request satisfies the observability condition; and
   the control circuitry is configured to control the interface circuitry to issue a read acknowledgement to the given requester acknowledging a to-be-translated read request in response to determining that the read request satisfies the observability condition.
9. The apparatus according to any preceding clause, wherein the control circuitry is configured to control the interface circuitry to issue the request acknowledgement to the given requester in response to determining that translation of the target address has completed.
10. The apparatus according to any preceding clause, comprising status storage circuitry configured to provide status information relating to the given requester;
   wherein the control circuitry is configured to set a write observability indicator in the status storage circuitry in dependence on whether all write requests received from the given requester satisfy the observability condition.
11. The apparatus according to clause 10, wherein the control circuitry is configured to set the write observability indicator in dependence on whether the given requester is in an idle state in which the given requester is expected to issue no further memory access requests.
12. The apparatus according to any preceding clause, comprising processing circuitry to execute instructions; wherein
   the interface circuitry comprises accelerator control interface circuitry configured to exchange control signals with at least one hardware accelerator configurable, based on instructions executed by the processing circuitry, to perform a delegated task; and
   the one or more requesters comprise the at least one hardware accelerator.
13. The apparatus according to clause 12, comprising memory management circuitry associated with the processing circuitry, to perform address translation in response to memory access instructions executed by the processing circuitry; and
   in response to the to-be-translated memory access request received at the interface circuitry from the given requester, the memory management circuitry associated with the processing circuitry is configured to translate the target address specified by the to-be-translated memory access request to a physical address of a memory system location to be accessed in response to the to-be-translated memory access request.
14. The apparatus according to any of clauses 12 and 13, in which the at least one hardware accelerator is private to a processor core comprising the processing circuitry.
15. The apparatus according to any preceding clause, wherein the control circuitry is configured to control the interface circuitry to issue a request acknowledgement to the given requester acknowledging the to-be-translated memory access request at a time when the to-be-translated memory access request does not satisfy the observability condition.
16. A non-transitory computer-readable medium storing computer-readable code for fabrication of the apparatus of any preceding clause.
17. A system comprising:
   the apparatus of any of clauses 1 to 15, implemented in at least one packaged chip;
   at least one system component; and
   a board,
   wherein the at least one packaged chip and the at least one system component are assembled on the board.
18. A chip-containing product comprising the system of clause 17, wherein the system is assembled on a further board with at least one other product component.
19. A method comprising:
   exchanging signals with one or more requesters; and
   in response to a to-be-translated memory access request received from a given requester, the to-be-translated memory access request specifying a target address to be translated to identify a location in a memory system to be accessed in response to the to-be-translated memory access request, issuing a request acknowledgement to the given requester acknowledging the to-be-translated memory access request independent of whether the to-be-translated memory access request satisfies an observability condition.
20. A computer program for controlling a host data processing apparatus to provide an instruction execution environment, the computer program comprising:
   interface program logic to exchange signals with one or more requesters; and
   control program logic; wherein
   in response to a to-be-translated memory access request received by the interface program logic from a given requester, the to-be-translated memory access request specifying a target address to be translated to identify a location in a memory system to be accessed in response to the to-be-translated memory access request, the control program logic is configured to control the interface program logic to issue a request acknowledgement to the given requester acknowledging the to-be-translated memory access request independent of whether the to-be-translated memory access request satisfies an observability condition.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: A, B and C” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
interface circuitry configured to exchange signals with one or more requesters; and
control circuitry; wherein
in response to a to-be-translated memory access request received at the interface circuitry from a given requester, the to-be-translated memory access request specifying a target address to be translated to identify a location in a memory system to be accessed in response to the to-be-translated memory access request, the control circuitry is configured to control the interface circuitry to issue a request acknowledgement to the given requester acknowledging the to-be-translated memory access request independent of whether the to-be-translated memory access request satisfies an observability condition.

2. The apparatus according to claim 1, wherein the observability condition is satisfied for a memory access request which is visible to coherency transactions of the memory system.

3. The apparatus according to claim 1, wherein the request acknowledgement enables the given requester to determine a relative ordering of the to-be-translated memory access request with respect to other memory access requests issued by the given requester.

4. The apparatus according to claim 3, wherein issuing the request acknowledgement enables the given requester to determine that a subsequent memory access request issued by the requester following receipt of the request acknowledgement is ordered with respect to the to-be-translated memory access request.

5. The apparatus according to claim 1, wherein in response to a barrier transaction received at the interface circuitry from the given requester, the control circuitry is configured to control the interface circuitry to issue a barrier response in response to determining that each memory access request of at least one type issued before the barrier transaction satisfies the observability condition.

6. The apparatus according to claim 5, wherein in response to a write barrier transaction received at the interface circuitry from the given requester, the control circuitry is configured to control the interface circuitry to issue a write barrier response in response to determining that each write request issued before the write barrier transaction satisfies the observability condition.

7. The apparatus according to claim 5, wherein in response to the barrier transaction, the interface circuitry is configured to stall a channel configured to receive the barrier transaction until the barrier response is issued.

8. The apparatus according to claim 1, wherein the control circuitry is configured to control the interface circuitry to issue a write acknowledgement to the given requester acknowledging a to-be-translated write request independent of whether the to-be-translated write request satisfies the observability condition; and
the control circuitry is configured to control the interface circuitry to issue a read acknowledgement to the given requester acknowledging a to-be-translated read request in response to determining that the read request satisfies the observability condition.

9. The apparatus according to claim 1, wherein the control circuitry is configured to control the interface circuitry to issue the request acknowledgement to the given requester in response to determining that translation of the target address has completed.

10. The apparatus according to claim 1, comprising status storage circuitry configured to provide status information relating to the given requester;
wherein the control circuitry is configured to set a write observability indicator in the status storage circuitry in dependence on whether all write requests received from the given requester satisfy the observability condition.

11. The apparatus according to claim 10, wherein the control circuitry is configured to set the write observability indicator in dependence on whether the given requester is in an idle state in which the given requester is expected to issue no further memory access requests.

12. The apparatus according to claim 1, comprising processing circuitry to execute instructions; wherein
the interface circuitry comprises accelerator control interface circuitry configured to exchange control signals with at least one hardware accelerator configurable, based on instructions executed by the processing circuitry, to perform a delegated task; and
the one or more requesters comprise the at least one hardware accelerator.

13. The apparatus according to claim 12, comprising memory management circuitry associated with the processing circuitry, to perform address translation in response to memory access instructions executed by the processing circuitry; and
in response to the to-be-translated memory access request received at the interface circuitry from the given requester, the memory management circuitry associated with the processing circuitry is configured to translate the target address specified by the to-be-translated memory access request to a physical address of a memory system location to be accessed in response to the to-be-translated memory access request.

14. The apparatus according to claim 12, in which the at least one hardware accelerator is private to a processor core comprising the processing circuitry.

15. The apparatus according to claim 1, wherein the control circuitry is configured to control the interface circuitry to issue a request acknowledgement to the given requester acknowledging the to-be-translated memory access request at a time when the to-be-translated memory access request does not satisfy the observability condition.

16. A non-transitory computer-readable medium storing computer-readable code for fabrication of the apparatus of claim 1.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17, wherein the system is assembled on a further board with at least one other product component.

19. A method comprising:
exchanging signals with one or more requesters; and
in response to a to-be-translated memory access request received from a given requester, the to-be-translated memory access request specifying a target address to be translated to identify a location in a memory system to be accessed in response to the to-be-translated memory access request, issuing a request acknowledgement to the given requester acknowledging the to-be-translated memory access request independent of whether the to-be-translated memory access request satisfies an observability condition.

20. A non-transitory computer-readable medium storing a computer program for controlling a host data processing apparatus to provide an instruction execution environment, the computer program comprising:
interface program logic to exchange signals with one or more requesters; and
control program logic; wherein
in response to a to-be-translated memory access request received by the interface program logic from a given requester, the to-be-translated memory access request specifying a target address to be translated to identify a location in a memory system to be accessed in response to the to-be-translated memory access request, the control program logic is configured to control the interface program logic to issue a request acknowledgement to the given requester acknowledging the to-be-translated memory access request independent of whether the to-be-translated memory access request satisfies an observability condition.
